(19) United States
(12) Patent Application Publication
(10) Pub. No.: US 2022/0148018 A1
(43) Pub. Date: May 12, 2022

(54) Systems and Methods for Automatic Persona Generation from Content and Association with Contents

(71) Applicant: IDS Technology, LLC, Arlington, VA (US)

(72) Inventors: Dongwook Shin, Potomac, MD (US); Tung Thanh Tran, Bradenton, FL (US); Jefferson D. Hoye, Arlington, VA (US); Matthew R. Ehlers, Raleigh, NC (US)

(21) Appl. No.: 17/524,485

(22) Filed: Nov. 11, 2021

Related U.S. Application Data
(60) Provisional application No. 63/112,340, filed on Nov. 11, 2020.

(51) Int. Cl. G06Q 30/02; G06N 3/00; G06F 16/9536

(52) U.S. Cl. CPC G06Q 30/0201; G06F 16/9536; G06N 3/006

(57) ABSTRACT

A method, computer program product, and computer system for collecting, by a computing device, a plurality of social media posts. Each social media post may be compared to one or more data structures to determine a similarity score associated with one or more entries in the one or more data structures. Inferred information may be identified about one or more users of the plurality of social media posts based upon, at least in part, the similarity score associated with one or more entries in the one or more data structures.

### RELATED CASES

This application claims the benefit of U.S. Provisional Application No. 63/112,340 filed on 11 Nov. 2020, the contents of which are all incorporated by reference.

### BACKGROUND

Generally, persona generation is a process that generates personas (or actors) in creating a virtual cyber space where a simulation of social media, e-commerce or cyber marketing may be performed.

### BRIEF SUMMARY OF DISCLOSURE

In one example implementation, a method, performed by one or more computing devices, may include but is not limited to collecting, by a computing device, a plurality of social media posts. Each social media post may be compared to one or more data structures to determine a similarity score associated with one or more entries in the one or more data structures. Inferred information may be identified about one or more users of the plurality of social media posts based upon, at least in part, the similarity score associated with one or more entries in the one or more data structures.

One or more of the following example features may be included. The inferred information may include personality information. The inferred information may include country information. The inferred information may include affiliation information. Identifying the inferred information may include determining a pair based upon a ranking of the similarity score. Identifying the inferred information may include generating a representative set of personas. Comparing each social media post to the one or more data structures to determine the similarity score associated with the one or more entries in the one or more data structures may include determining similarities between one or more keywords in the plurality of social media posts and the one or more data structures.

In another example implementation, a computing system may include one or more processors and one or more memories configured to perform operations that may include but are not limited to collecting a plurality of social media posts. Each social media post may be compared to one or more data structures to determine a similarity score associated with one or more entries in the one or more data structures. Inferred information may be identified about one or more users of the plurality of social media posts based upon, at least in part, the similarity score associated with one or more entries in the one or more data structures.

One or more of the following example features may be included. The inferred information may include personality information. The inferred information may include country information. The inferred information may include affiliation information. Identifying the inferred information may include determining a pair based upon a ranking of the similarity score. Identifying the inferred information may include generating a representative set of personas. Comparing each social media post to the one or more data structures to determine the similarity score associated with the one or more entries in the one or more data structures may include determining similarities between one or more keywords in the plurality of social media posts and the one or more data structures.

In another example implementation, a computer program product may reside on a computer readable storage medium having a plurality of instructions stored thereon which, when executed across one or more processors, may cause at least a portion of the one or more processors to perform operations that may include but are not limited to collecting a plurality of social media posts. Each social media post may be compared to one or more data structures to determine a similarity score associated with one or more entries in the one or more data structures. Inferred information may be identified about one or more users of the plurality of social media posts based upon, at least in part, the similarity score associated with one or more entries in the one or more data structures.

One or more of the following example features may be included. The inferred information may include personality information. The inferred information may include country information. The inferred information may include affiliation information. Identifying the inferred information may include determining a pair based upon a ranking of the similarity score. Identifying the inferred information may include generating a representative set of personas. Comparing each social media post to the one or more data structures to determine the similarity score associated with the one or more entries in the one or more data structures may include determining similarities between one or more keywords in the plurality of social media posts and the one or more data structures.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of an analysis process coupled to an example distributed computing network according to one or more example implementations of the disclosure;

FIG. 2 is an example diagrammatic view of a client electronic device of FIG. 1 according to one or more example implementations of the disclosure;

FIG. 3 is an example flowchart of an analysis process according to one or more example implementations of the disclosure;

FIG. 4 is an example flowchart of an analysis process according to one or more example implementations of the disclosure;

FIG. 5 is an example diagrammatic view of the use of Word Embedding in calculating keywords by an analysis process according to one or more example implementations of the disclosure;

FIG. 6 is an example diagrammatic view of the use of Word Embedding in calculating keywords by an analysis process according to one or more example implementations of the disclosure; and

FIG. 7 is an example diagrammatic view of sorted features in the order of frequencies for use by an analysis process according to one or more example implementations of the disclosure.

Like reference symbols in the various drawings may indicate like elements.

### DETAILED DESCRIPTION

### System Overview:

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN), a wide area network (WAN), a body area network BAN), a personal area network (PAN), a metropolitan area network (MAN), etc., or the connection may be made to an external computer (for example, through the internet using an Internet Service Provider). In some implementations, electronic circuitry including, for example, programmable logic circuitry, an application specific integrated circuit (ASIC), field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

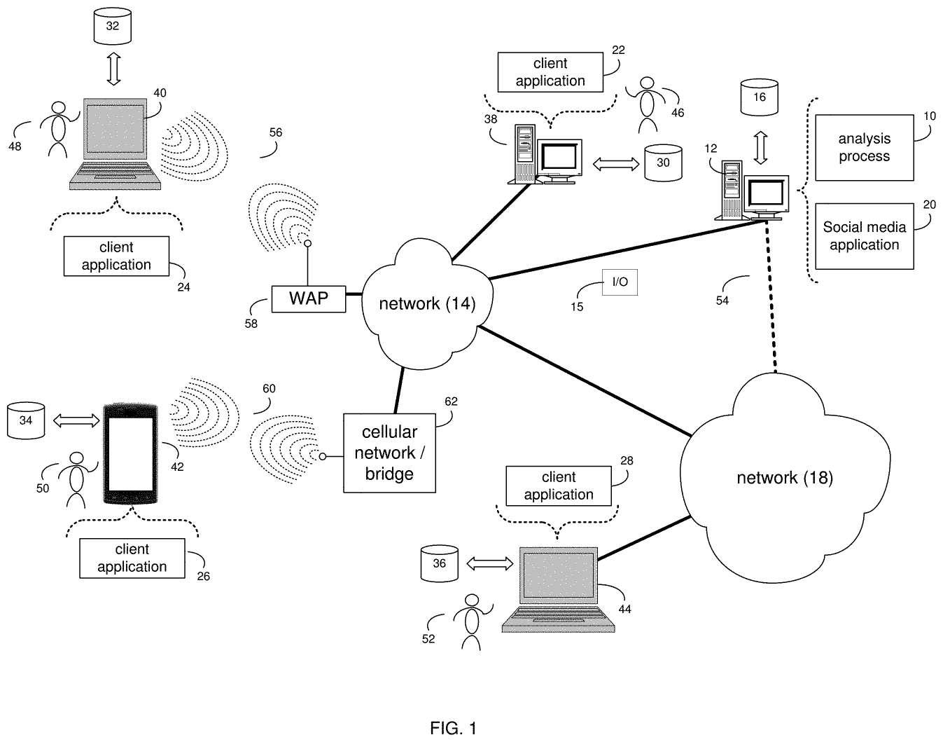

Referring now to the example implementation of FIG. 1, there is shown analysis process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). A SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a analysis process, such as analysis process 10 of FIG. 1, may collect, by a computing device, a plurality of social media posts. Each social media post may be compared to one or more data structures to determine a similarity score associated with one or more entries in the one or more data structures. Inferred information may be identified about one or more users of the plurality of social media posts based upon, at least in part, the similarity score associated with one or more entries in the one or more data structures.

In some implementations, the instruction sets and subroutines of analysis process 10, which may be stored on storage device, such as storage device 16, coupled to computer 12, may be executed by one or more processors and one or more memory architectures included within computer 12. In some implementations, storage device 16 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 16 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 14 may be connected to one or more secondary networks (e.g., network 18), examples of which may include but are not limited to: a local area network; a wide area network or other telecommunications network facility; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, analysis process 10 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute a social media application (e.g., social media application 20), examples of which may include, but are not limited to, e.g., Facebook, Twitter, Instagram, Tick Tock, or other social media application where a user may express their comments on the internet. In some implementations, analysis process 10 and/or social media application 20 may be accessed via one or more of client applications 22, 24, 26, 28. In some implementations, analysis process 10 may be a standalone application, or may be an applet/application/script/extension that may interact with and/or be executed within social media application 20, a component of social media application 20, and/or one or more of client applications 22, 24, 26, 28. In some implementations, social media application 20 may be a standalone application, or may be an applet/application/script/extension that may interact with and/or be executed within analysis process 10, a component of analysis process 10, and/or one or more of client applications 22, 24, 26, 28. In some implementations, one or more of client applications 22, 24, 26, 28 may be a standalone application, or may be an applet/application/script/extension that may interact with and/or be executed within and/or be a component of analysis process 10 and/or social media application 20. Examples of client applications 22, 24, 26, 28 may include, but are not limited to, e.g., Facebook, Twitter, Instagram, Tick Tock, or other social media application where a user may express their comments on the internet, a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM).

Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet, a server, a television, a smart television, a smart speaker, an Internet of Things (IoT) device, a media (e.g., audio/video, photo, etc.) capturing and/or output device, an audio input and/or recording device (e.g., a handheld microphone, a lapel microphone, an embedded microphone (such as those embedded within eyeglasses, smart phones, tablet computers and/or watches, etc.), and a dedicated network device. Client electronic devices 38, 40, 42, 44 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 22, 24, 26, 28 may be configured to effectuate some or all of the functionality of analysis process 10 (and vice versa). Accordingly, in some implementations, analysis process 10 may be a purely server-side application, a purely client-side application, or a hybrid server-side/client-side application that is cooperatively executed by one or more of client applications 22, 24, 26, 28 and/or analysis process 10.

In some implementations, one or more of client applications 22, 24, 26, 28 may be configured to effectuate some or all of the functionality of social media application 20 (and vice versa). Accordingly, in some implementations, social media application 20 may be a purely server-side application, a purely client-side application, or a hybrid server-side/client-side application that is cooperatively executed by one or more of client applications 22, 24, 26, 28 and/or social media application 20. As one or more of client applications 22, 24, 26, 28, analysis process 10, and social media application 20, taken singly or in any combination, may effectuate some or all of the same functionality, any description of effectuating such functionality via one or more of client applications 22, 24, 26, 28, analysis process 10, social media application 20, or combination thereof, and any described interaction(s) between one or more of client applications 22, 24, 26, 28, analysis process 10, social media application 20, or combination thereof to effectuate such functionality, should be taken as an example only and not to limit the scope of the disclosure.

In some implementations, one or more of users 46, 48, 50, 52 may access computer 12 and analysis process 10 (e.g., using one or more of client electronic devices 38, 40, 42, 44) directly through network 14 or through secondary network 18. Further, computer 12 may be connected to network 14 through secondary network 18, as illustrated with phantom link line 54. Analysis process 10 may include one or more user interfaces, such as browsers and textual or graphical user interfaces, through which users 46, 48, 50, 52 may access analysis process 10.

In some implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, 802.11n, 802.11ac, Wi-Fi®, RFID, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown by example directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

In some implementations, various I/O requests (e.g., I/O request 15) may be sent from, e.g., client applications 22, 24, 26, 28 to, e.g., computer 12 (and vice versa). Examples of I/O request 15 may include but are not limited to, data write requests (e.g., a request that content be written to computer 12) and data read requests (e.g., a request that content be read from computer 12).

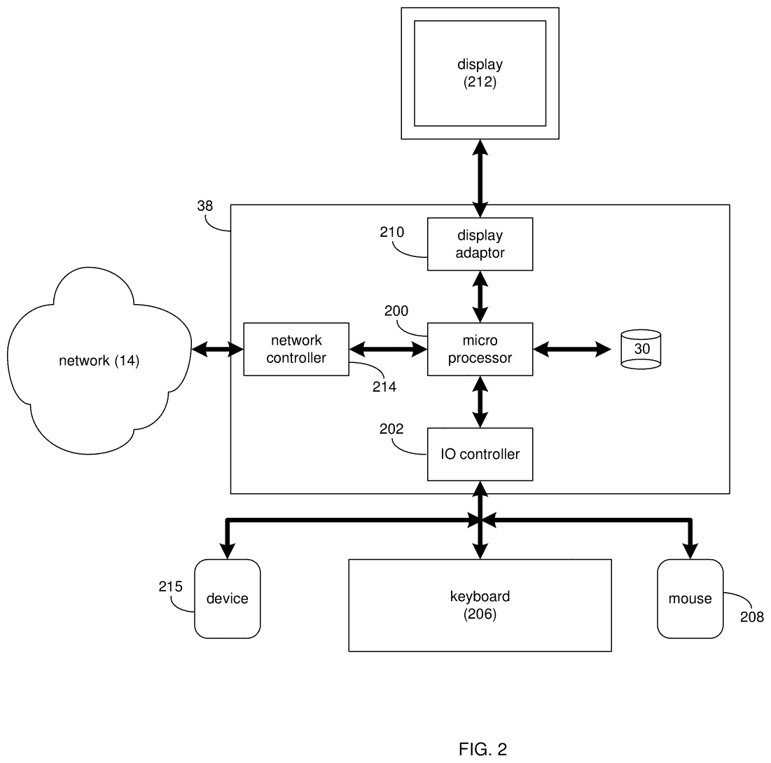

Referring also to the example implementation of FIG. 2, there is shown a diagrammatic view of client electronic device 38. While client electronic device 38 is shown in this figure, this is for example purposes only and is not intended to be a limitation of this disclosure, as other configurations are possible. Additionally, any computing device capable of executing, in whole or in part, analysis process 10 may be substituted for client electronic device 38 (in whole or in part) within FIG. 2, examples of which may include but are not limited to computer 12 and/or one or more of client electronic devices 38, 40, 42, 44.

In some implementations, client electronic device 38 may include a processor (e.g., microprocessor 200) configured to, e.g., process data and execute the above-noted code/instruction sets and subroutines. Microprocessor 200 may be coupled via a storage adaptor to the above-noted storage device(s) (e.g., storage device 30). An I/O controller (e.g., I/O controller 202) may be configured to couple microprocessor 200 with various devices (e.g., via wired or wireless connection), such as keyboard 206, pointing/selecting device (e.g., touchpad, touchscreen, mouse 208, etc.), custom device (e.g., device 215), USB ports, and printer ports. A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to the above-noted network 14 (e.g., the Internet or a local area network).

Generally, persona generation is a process that generates personas (or actors) in creating a virtual cyber space where a simulation of social media, e-commerce or cyber marketing may be performed. Many companies may use persona generation to find their core customers and engage them virtually to learn their interest and boost their sales. Generated personas should mimic the real-world people as closely as possible, so that these cyber setting can simulate the real world in order to achieve the desired goal. Currently, in most cases, persona generation is done manually with analyzing user inputs and creating personas as the user input directs. For instance, some companies may offer many types of templates of personas and let users select what they like, filling the characteristics of persons as the users choose. Other types of manual persona generation tools may give more freedom to users and lets the users highlight the features of personas, so that the users can segment their focus of customers.

Some systems may offer automatic persona generation tools, which aim to create a large number of personas automatically, so that it can decrease the degree of user intervention and minimize the manual effort. For instance, some systems may generate persona automatically by analyzing the user interaction to online content or user-to-user interaction. In such an approach, the core algorithm is representing user interaction to content as a matrix and transforms the matrix into resulting personas. However, this method as understood only takes the user interaction to content, ignoring the textual meaning of online content and thus losing a potentially valuable source of information.

Therefore, as will be discussed in greater detail below, the present disclosure, in some implementations, may generate personas automatically from textual contents, including, e.g., Tweets, Facebook conversation and other various types of online conversation (e.g., blog posts, articles, etc.) or social media. In some implementations, the analysis process may look at each post (e.g., a Tweet, a Facebook post, etc.) as a unit and may infer (as example only) Big-5 personality, gender, country and/or political affiliation from each textual unit. After inferring these features from input texts (which may be tens of thousands of Tweets or Facebook conversations), the analysis process may classify those, generating the most representative personas for the input texts. Thus, each output persona may have these example and non-limiting characteristics: Big-5 personality (e.g., Neuroticism, Extraversion, Openness, Agreeableness, Conscientiousness), gender, country, and/or political affiliation. The idea of inferring personas is to calculate the similarity of words in each post and representative words of Big-5 personality (or country and affiliation, etc.) using, e.g., Word Embedding and choose the highest personality (or country and affiliation, etc.). Word Embedding, generally, is a Machine Learning model that has been trained by a large set of text and learned all the similarities between words.

The Analysis Process:

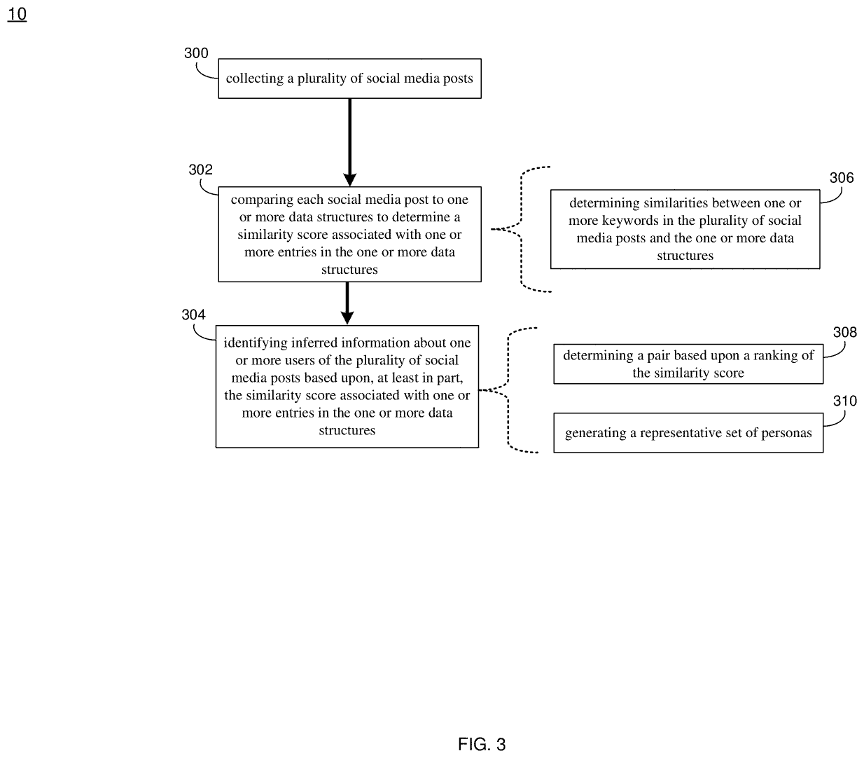

As discussed above and referring also at least to the example implementations of FIGS. 3-7, analysis process 10 may collect 300, by a computing device, a plurality of social media posts. Analysis process 10 may compare 302 each social media post to one or more data structures to determine a similarity score associated with one or more entries in the one or more data structures. Analysis process 10 may identify 304 inferred information about one or more users of the plurality of social media posts based upon, at least in part, the similarity score associated with one or more entries in the one or more data structures.

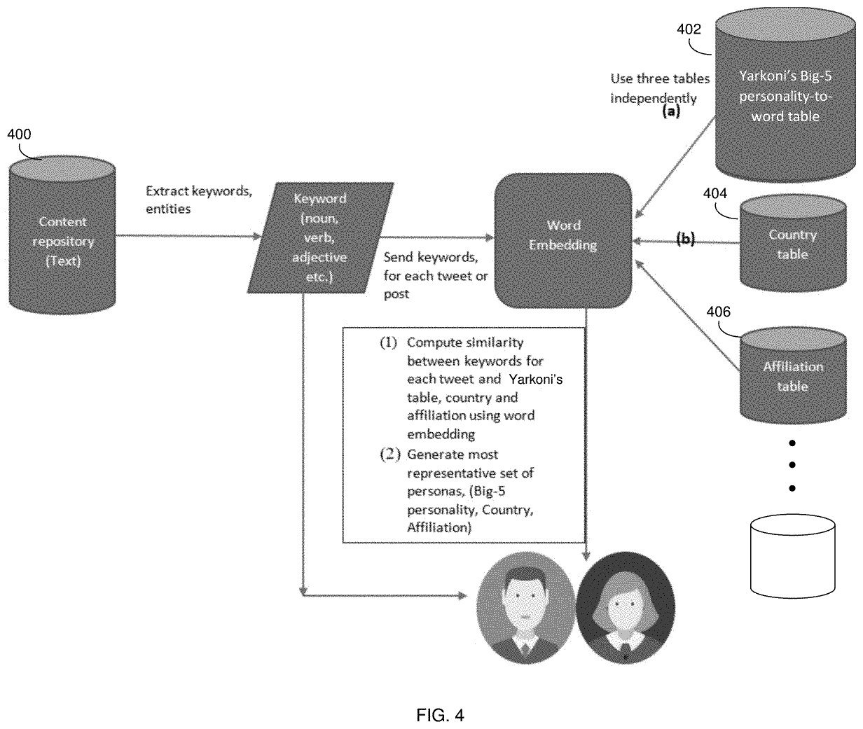

In some implementations, analysis process 10 may collect 300, by a computing device, a plurality of social media posts. For example, as will be discussed in greater detail below and referring at least to the example implementation of FIG. 4, an example flowchart of analysis process 10, that includes content text repository 400, personality-to-word table 402, country table 404 and affiliation table 406. In some implementations, analysis process 10 may collect from input content text repository 400 where keywords and entity information may be extracted. The input repository may include, e.g., a set of “tweets”, Facebook posts, new articles and other text sources. Analysis process 10 may extract keyword(s) (e.g., noun, adjective, verbs, etc.) and entities from these texts using Natural Language Processing tools. For example, suppose there are three input tweet messages, (1) “An attack on our troops is awful.”, (2) “Let's not forget about the Iraq war, the war on terror”, and (3) “As a combat veteran, how has pathetic killing in Afghanistan impacted the peace?”. Using NLP tools, analysis process 10 may extract keywords from above Tweets, (1-k) “attack, troop, awful”, (2-k) “forget, Iraq, war, terror” and (3-k) “combat, veteran, pathetic, killing, Afghanistan, impacted, peace”. Analysis process 10 may also extracts entities from these tweets employing similar NLP tools.

In some implementations, analysis process 10 may compare 302 each social media post to one or more data structures to determine a similarity score associated with one or more entries in the one or more data structures. For example, in some implementations, using these keywords and personality-to-word table 402 (an example of which may include Yarkoni's Big-5 personality-to-word table as one of the data structures), analysis process 10 may compute similarity between each tweet and each personality. Yarkoni's Big-5 personality-to-word table has a set of words and their weight for each Big-5 personality. As Yarkoni's table only contains hundreds of words and most of tweet keyword(s) would not match with those, analysis process 10 may use Word Embedding to compensate for this problem. Word Embedding is, generally, a Machine Learning model that has been trained by a large set of text and learned all the similarities between words. Therefore, in the similarity computation, analysis process 10 may use the weight of Yarkoni's table if keyword in tweets exist in Yarkoni's table. If not, analysis process 10 may use Word embedding and compute similarities of keywords in tweets and words in Yarkoni's table. The computation will be discussed further below.

In some implementations, the similarity between tweets and country (or affiliation or any other data structures) may be computed in a similar way using Word Embedding. But this time, entity information may be extracted from each tweet and similarity between this entity information may be compared with each country name (or affiliation). Country (or affiliation) of each of the tweets may be determined, in such a way the highest similarity value between a country (or affiliation) and entities in the tweet is chosen.

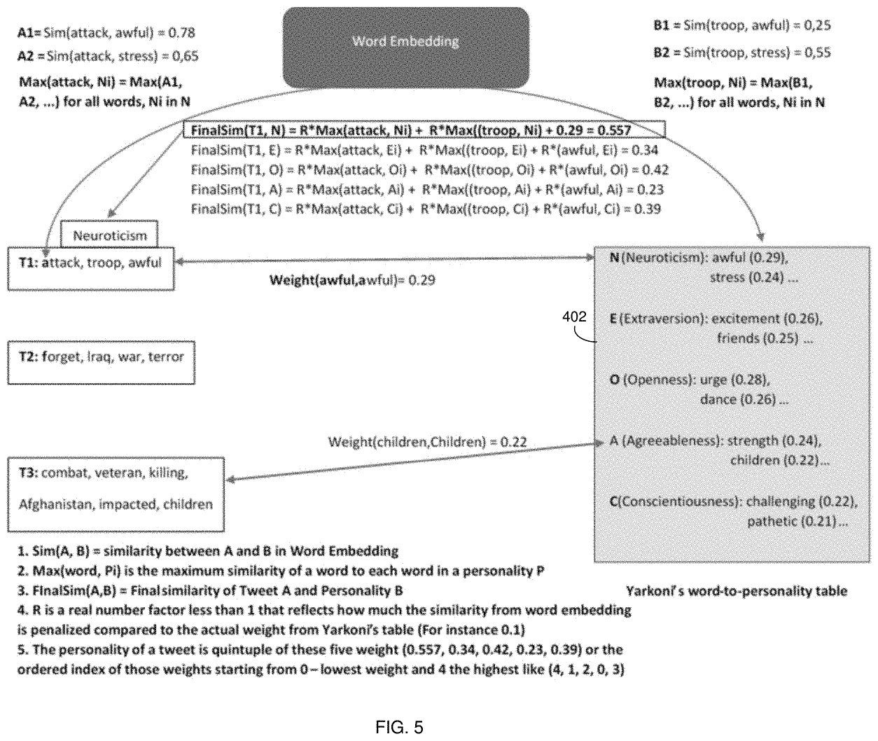

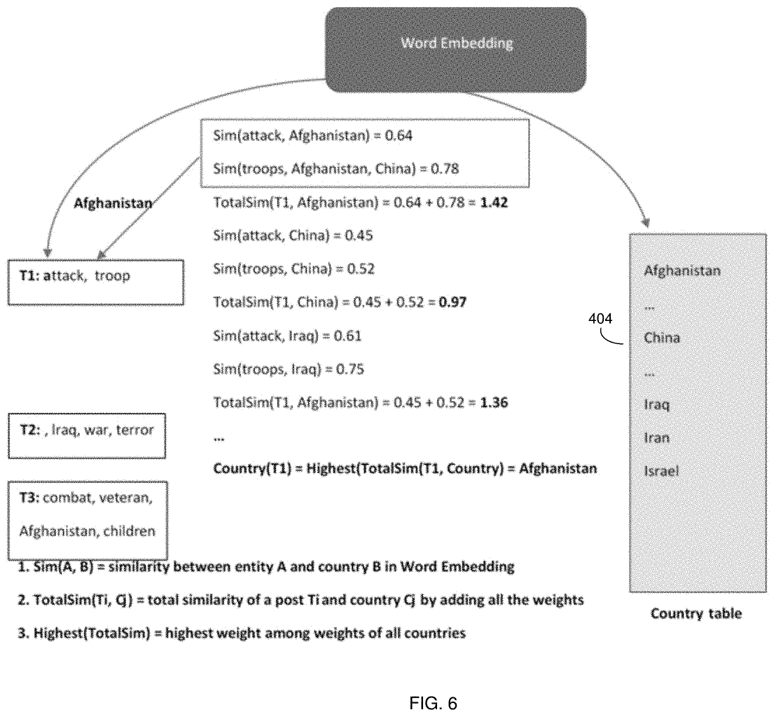

Referring to the example implementations of FIGS. 5 and 6, an example diagrammatic view of the use of Word Embedding in calculating keywords for the word-to personality table and calculating keywords for the country table are shown. FIG. 5 shows analysis process 10 using Word Embedding in calculating keywords obtained from each Tweet (and/or Facebook post or other media post) and Big-5 personality table 402 (from FIG. 4). The words may be associated with weights to Big-5 personalities. The problem is that this list of words has only hundreds of words and it is not possible to assign each post to one of Big-5 personality using only this table. As such, analysis process 10 may employ Word Embedding as well, to calculate the similarities between keywords and Big-5 personalities (as well as country, affiliation, or any other data point).

In some implementations, comparing 302 each social media post to the one or more data structures to determine the similarity score associated with the one or more entries in the one or more data structures may include determining 306 similarities between one or more keywords in the plurality of social media posts and the one or more data structures. For instance, suppose there is a list of keywords, “attack, troop, awful”, which is obtained from the post “Attack on our troop is awful.” In some implementations, analysis process 10 may pick the first word “attack” in the list and look up the personality table, checking if the word is in the table. As it is not listed in the table, analysis process 10 may now look up the Word Embedding, retrieving the similarities between “attack” and all the words in Neuroticism and choosing the highest similarity of those. That is Max(attack, Ni) in FIG. 5. Analysis process 10 may then look at the next keyword, “troop” and does the same calculation because the word does not appear in the personality table. So, analysis process 10 may find Max(troop, Ni). Analysis process 10 may then look at the last word, “awful” and check if the word is in the personality table. As it is in the Neuroticism category in the table, analysis process 10 may retrieve its weight 0.29. Now, as FIG. 5 suggests, the similarity between attack and awful is 0.78 (this is a hypothetical value and it varies according to which Word Embedding to use) and suppose that it is the highest value between words in Neuroticism (Max(attack, Ni)). This value is penalized by multiplying with the factor R, which is a real number less than 1, but greater than 0. Assume for example purposes only that R is 0.2. Then, the R*Max(attack, Ni) is 0.156. Likewise, the value R*Max(troop, Ni) is computed as 0.2*Max(0.25, 0.55)=0.11. So if analysis process 10 adds all these three values, 0.29+0.156+0.11=0.556.

In some implementations, analysis process 10 may identify 304 inferred information about one or more users of the plurality of social media posts based upon, at least in part, the similarity score associated with one or more entries in the one or more data structures, and in some implementations, the inferred information may include personality information. For example, analysis process 10 may calculate the similarities for the other four categories (Extraversion, Openness, Agreeableness and Conscientiousness, although other categories may also be used instead of or in addition to those listed) and generate values for each categories (which are the expression and 5 values under the Word Embedding rectangle in FIG. 5). As such, the weight of each Big-5 personality may be calculated as a quintuple (0.557, 0.34, 0.42, 0.23, 0.39). The final personality value of a post may be either (0.557, 0.34, 0.42, 0.23, 0.39) or the ordered index of each weight (e.g., 4 as the highest weight and 0 as the lowest one), (4, 1, 3, 0, 2).

In some implementations, the inferred information may include country information, and in some implementations, the inferred information may include affiliation information. For example, FIG. 6 is similar to FIG. 5, in that it may use the same Word Embedding used in FIG. 5, but FIG. 6 is shown using the list of countries (country table 404 from FIG. 4) instead of personality tables. When country and affiliation are computed, entities are extracted first from each post. There are many known entity extraction tools from natural language that may be used. Entities may be a little different from keyword in that entities are names corresponding to a real world entity like country name, business name, political affiliation, etc.

In some implementations, identifying 304 the inferred information may include determining 308 a pair based upon a ranking of the similarity score. For instance, in FIG. 6, entities like “attack” and “troop” may be extracted from the post “Attack on our troop is awful”. Next, each entity may be paired with each country in the country table and their similarity may be computed from Word Embedding. In FIG. 6, assume for example purposes only that the similarity of “attack” and “Afghanistan” is 0.64 and that of “troop” and “Afghanistan” is 0.78. Then, the total similarity of post T1 and country Afghanistan is 0.64+0.78=1.42. This computation is repeated with all the countries and the country that produces the highest total score is chosen as the inferred country of the post as shown in FIG. 6. Similarly, affiliation may be inferred/extracted in the same way when replacing country name with affiliation name. Thus, for brevity, the explanation for the inference of affiliation is not discussed. It will also be appreciated that in addition to Big-5 personality, country, and affiliation, a separate gender and age extraction algorithm may be similarly used by analysis process 10 to infer those from posts or other media.

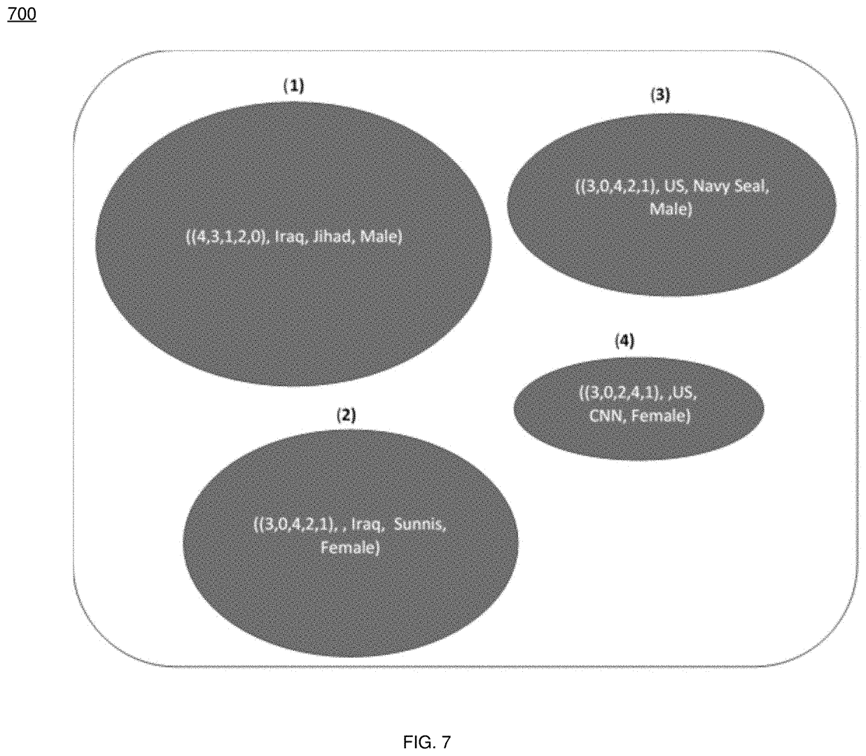

In some implementations, when all of these Big-5 personality, country, affiliation, gender and age information are extracted, analysis process 10 may put all those into a data structure (e.g., like dictionary or set) and sort these features in the order of frequencies. And the features that appear most frequently to least may be chosen one by one until enough numbers of the personality features are chosen. For instance, suppose analysis process 10 orders these features by their frequencies and the most frequent ones are ((4, 3, 1, 2, 0), Iraq, Jihad, Male) and the second most frequently appearing one is ((3, 0, 4, 2, 1), Iraq, Sunnis, Female) and third is ((3, 0, 4, 2, 1), US, Navy Seal, Male) and so one as shown in FIG. 7, the personas are generated in this order—((4, 3, 1, 2, 0), Iraq, Jihad, Male), ((3, 0, 4, 2, 1), Iraq, Sunnis, Female), ((3, 0, 4, 2, 1), US, Navy Seal, Male), ((3, 0, 2, 4, 1), US, CNN, Female).

In some implementations, identifying 304 the inferred information may include generating 310 a representative set of personas. An example of final personality personas 700 are shown in the example implementation of FIG. 7. For instance, in some implementations, analysis process 10 may also order Big-5 personality, country, affiliation and gender separately and produce the final personalities by combining the most frequently features together. For instance, referring to FIG. 7, if (4, 3, 1, 2, 0) is most frequently appearing personality followed by (3, 0, 4, 2, 1), (3, 0, 4, 2, 1) and (3, 0, 2, 4, 1) and countries are ordered like Iraq, US, Afghanistan, Iran, etc., analysis process 10 may identify and produce personas by choosing the topmost one from each feature and combine those to identify and produce the final personas. In this case, analysis process 10 is able to produce personas like, e.g., ((3, 0, 4, 2, 1), Iraq, . . . ), ((3, 0, 4, 2, 1), US, . . . ), ((3, 0, 4, 2, 1), Afghanistan . . . ), ((3, 0, 4, 2, 1), Iran . . . ), ((3, 0, 4, 2, 1), Iraq, . . . ), ((3, 0, 4, 2, 1), US, . . . ), ((3, 0, 4, 2, 1), Afghanistan, . . . ), ((3, 0, 4, 2, 1), Iran, . . . ), . . . , etc.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
collecting, by a computing device, a plurality of social media posts;
comparing each social media post to one or more data structures to determine a similarity score associated with one or more entries in the one or more data structures; and
identifying inferred information about one or more users of the plurality of social media posts based upon, at least in part, the similarity score associated with one or more entries in the one or more data structures.

2. The computer-implemented method of claim 1 wherein the inferred information includes personality information.

3. The computer-implemented method of claim 1 wherein the inferred information includes country information.

4. The computer-implemented method of claim 1 wherein the inferred information includes affiliation information.

5. The computer-implemented method of claim 1 wherein identifying the inferred information includes determining a pair based upon a ranking of the similarity score.

6. The computer-implemented method of claim 1 wherein identifying the inferred information includes generating a representative set of personas.

7. The computer-implemented method of claim 1 wherein comparing each social media post to the one or more data structures to determine the similarity score associated with the one or more entries in the one or more data structures includes determining similarities between one or more keywords in the plurality of social media posts and the one or more data structures.

8. A computer program product residing on a computer readable storage medium having a plurality of instructions stored thereon which, when executed across one or more processors, causes at least a portion of the one or more processors to perform operations comprising:
collecting a plurality of social media posts;
comparing each social media post to one or more data structures to determine a similarity score associated with one or more entries in the one or more data structures; and
identifying inferred information about one or more users of the plurality of social media posts based upon, at least in part, the similarity score associated with one or more entries in the one or more data structures.

9. The computer program product of claim 8 wherein the inferred information includes personality information.

10. The computer program product of claim 8 wherein the inferred information includes country information.

11. The computer program product of claim 8 wherein the inferred information includes affiliation information.

12. The computer program product of claim 8 wherein identifying the inferred information includes determining a pair based upon a ranking of the similarity score.

13. The computer program product of claim 8 wherein identifying the inferred information includes generating a representative set of personas.

14. The computer program product of claim 8 wherein comparing each social media post to the one or more data structures to determine the similarity score associated with the one or more entries in the one or more data structures includes determining similarities between one or more keywords in the plurality of social media posts and the one or more data structures.

15. A computing system including one or more processors and one or more memories configured to perform operations comprising:
collecting a plurality of social media posts;
comparing each social media post to one or more data structures to determine a similarity score associated with one or more entries in the one or more data structures; and
identifying inferred information about one or more users of the plurality of social media posts based upon, at least in part, the similarity score associated with one or more entries in the one or more data structures.

16. The computing system of claim 15 wherein the inferred information includes personality information.

17. The computing system of claim 15 wherein the inferred information includes country information.

18. The computing system of claim 15 wherein the inferred information includes affiliation information.

19. The computing system of claim 15 wherein identifying the inferred information includes determining a pair based upon a ranking of the similarity score.

20. The computing system of claim 15 wherein identifying the inferred information includes generating a representative set of personas.

21. The computing system of claim 15 wherein comparing each social media post to the one or more data structures to determine the similarity score associated with the one or more entries in the one or more data structures includes determining similarities between one or more keywords in the plurality of social media posts and the one or more data structures.
